(19) United States
(12) Patent Application Publication
(10) Pub. No.: US 2011/0145280 A1
(43) Pub. Date: Jun. 16, 2011

(54) SYSTEM FOR INQUIRING ABOUT FITNESS OF BEVERAGE AS BATTERY FUEL

(75) Inventors: Yuichi Tokita, Kanagawa (JP); Hideki Sakai, Kanagawa (JP); Hideyuki Kumita, Kanagawa (JP); Ryuhei Matsumoto, Kanagawa (JP); Hiroki Mita, Kanagawa (JP); Taiki Sugiyama, Kanagawa (JP)

(73) Assignee: SONY CORPORATION, Tokyo (JP)

(21) Appl. No.: 12/950,396

(22) Filed: Nov. 19, 2010

(30) Foreign Application Priority Data
Dec. 10, 2009 (JP) P2009-280563

(51) Int. Cl. G06F 17/30

(52) U.S. Cl. 707/769; 707/E17.014

(57) ABSTRACT

Disclosed herein is a system for inquiring about fitness of a beverage as battery fuel, including a search request receiving section configured to receive an input of beverage information regarding a beverage as a search request, a storage section having stored therein a reference database in which search requests and performance data of fuel cells are associated with each other, a search section configured to automatically search the reference database for performance data which coincides with the search request, and a search answer outputting section configured to output a search answer.

### CROSS REFERENCES TO RELATED APPLICATIONS

The present application claims priority to Japanese Priority Patent Application JP 2009-280563 filed in the Japan Patent Office on Dec. 10, 2009, the entire content of which is hereby incorporated by reference.

### BACKGROUND

This application relates to a system for inquiring about fitness of a beverage as battery fuel where the beverage is used as fuel solution of a fuel cell.

In recent years, a biotechnology fuel cell (hereinafter referred to simply as “fuel cell”) wherein oxidoreductase is fixed as a catalyst on at least one of an anode electrode and a cathode electrode has been and is being developed. Since a fuel cell can extract electrons efficiently from fuel whose reaction is difficult with ordinary industrial catalysts such as glucose and ethanol to achieve a high capacity, also it is possible to use a beverage containing glucose, ethanol or the like as fuel solution. For example, Japanese Patent Laid-Open No. 2009-048858 (hereinafter referred to as Patent Document 1), discloses a power supplying apparatus including a fuel cell section wherein a beverage is used as fuel.

### SUMMARY

It is expected that, if a beverage on the market containing glucose, ethanol or the like can be used as fuel solution of a fuel cell, then a problem of fuel supply which is a subject to a fuel cell can be solved. However, a great number of kinds of beverages on the market are available and naturally include those beverages which are suitable for fuel solution of a fuel cell and those beverages which are not suitable for fuel solution of a fuel cell. Further, it is estimated that also those beverages which are suitable for fuel solution are different from each other in a fuel cell performance achieved where each of the beverages is applied as fuel solution.

Therefore, to a user of a fuel cell, information is required what beverage should be used as fuel solution for the fuel cell or what output power is obtained with the fuel cell in which a certain beverage is used.

Therefore, it is demanded to provide an inquiry system by which a user of a fuel cell can simply and easily decide fitness of a beverage as battery fuel where the user uses a beverage on the market as fuel of the fuel cell.

According to an embodiment, there is provided a system for inquiring about fitness of a beverage as battery fuel, including search request receiving means for receiving an input of beverage information regarding a beverage as a search request, storage means having stored therein a reference database in which search requests and performance data of fuel cells are associated with each other, search means for automatically searching the reference database for performance data which coincides with the search request, and search answer outputting means for outputting a search answer.

Preferably, the system is configured such that a server and a plurality of clients are connected to each other through a network. Each of the clients includes inputting means for allowing a user to input beverage information regarding a beverage as a search request therethrough, information transmission means for transmitting the inputted search request to the server, search answer reception means for receiving, where the server stores performance data which coincides with the search request, the performance data as a search answer from the server, and presentation means for presenting the received search answer to the user, the server including search request receiving means for receiving an input of beverage information as a search request, storage means having stored therein a reference database in which search requests and performance data of fuel cells are associated with each other, search means for automatically searching, where a search request is received from the client, the reference database for performance data which coincides with the search request, and search answer outputting means for transmitting a search answer to the client.

Preferably, the beverage information and the performance data in the reference database are associated with each other through ingredient data of beverages. Further preferably, the reference database associates the beverage information and the performance data with each other based on a degree of substrate fitness and/or a degree of activity inhibition of ingredients included in the beverage with respect to an enzyme fixed to a solid phase in an electrode of the fuel cell. Preferably, a plurality of such reference databases are provided for individual kinds of fuel cells.

In the system, the ingredients may include one or more elements selected from the group having sugars, alcohols, fats, organic acids and amino acids. The beverage information may be information regarding one or more pieces of information selected from a product name and a raw material name of the beverage and a code for recording the product name and raw material name. The beverage information is image information obtained by picking up an image of the code.

Thus, the present application provides an inquiry system wherein, where a user of a fuel cell intends to use a beverage on the market as fuel for the fuel cell, the fitness of the beverage as the cell fuel can be decided simply and conveniently.

Additional features and advantages are described herein, and will be apparent from the following Detailed Description and the figures.

### BRIEF DESCRIPTION OF THE FIGURES

FIG. 1 is a block diagram showing an example of a configuration of a system according to the present application;

FIG. 2 is a view illustrating an example of a configuration of a reference database; and

FIG. 3 is a sequence diagram illustrating an example of operation of the system.

### DETAILED DESCRIPTION

Embodiments of this application will be described below with reference to the drawings. The description of the embodiment is given in the following order:

1. Beverage Inquiry System

(1) System

(2) Client

(3) Server

(4) Reference Database

2. System Operation

1. Beverage Inquiry System

(1) System

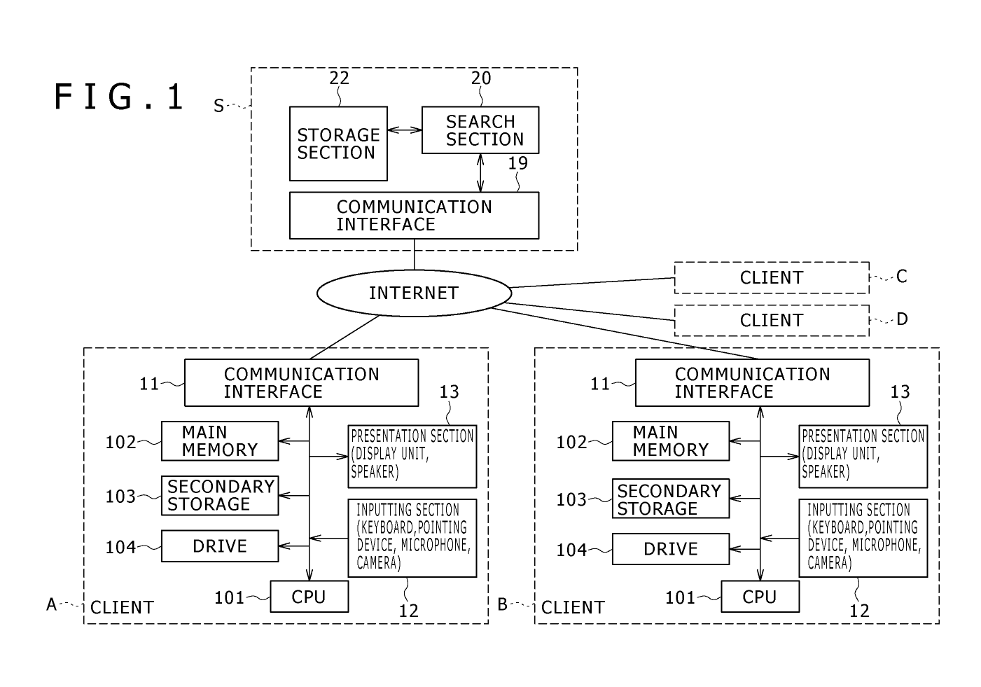

FIG. 1 shows an example of a configuration of a system (hereinafter referred to as “beverage inquiry system”) for inquiring about fitness of a beverage as battery fuel according to the present application.

Referring to FIG. 1, the beverage inquiry system is configured by connecting a server S and a plurality of clients, in FIG. 1, clients A to D, through a network which is, for example, the Internet.

The clients A to D are individually configured from a personal computer (PC), a work station (WS), a mobile computer, or a computer which functions as an Internet terminal such as a portable telephone set. As a form of connection of each of the clients A to D to the Internet, any of existing forms of connection such as a dialup IP connection and a private line connection can be applied.

(2) Client

Since the clients A to D individually have the same configuration, description is given of the client A as a representative of them. The client A includes a CPU 101, a main memory 102 connected to the CPU 101 through a bus, a secondary storage 103 and a communication interface 11 which controls a communication process with the server S. Further, the CPU 101 is connected to an inputting section 12 and a presentation section 13 through a bus. As the inputting section 12, a keyboard, a pointing device such as a mouse, a track ball, a joystick or the like, a microphone, a camera and so forth may be connected. Meanwhile, as the presentation section 13, a display unit, a speaker and so forth may be connected.

The secondary storage 103 stores a plurality of programs and data used upon execution of the programs. The main memory 102 is used as a working area of the CPU 101 and a video memory. The CPU 101 loads a program stored in the secondary storage 103 to the main memory 102 and then executes the loaded program to cause a computer to function as the client A.

In the present embodiment, the CPU 101 executes a program to cause the inputting section 12 to function as a section which allows a user to input, as a search request, beverage information regarding a beverage and/or fuel cell information regarding a fuel cell. Further, the communication interface 11 functions as an information transmission section for transmitting inputted beverage information and/or fuel cell information to the server S and as a search answer reception section for receiving, where the server S stores performance data which coincides with the transmitted beverage information and/or fuel cell information, the performance data as a search answer from the server S. The presentation section 13 functions as a section for presenting the received search answer to the user.

(3) Server

The server S may be configured using a PC, a WS, a server machine for exclusive use or the like. The server S includes a CPU not shown, a main memory not shown connected to the CPU through a bus, a secondary storage not shown and a communication interface 19 which controls communication with the clients A to D.

The CPU of the server S loads various programs stored in the secondary storage into the main memory and then executes the loaded programs so that it functions as an apparatus including a storage section 22 which stores a reference database wherein search requests and performance data of fuel cells are associated with each other and a search section 20 for automatically searching, where a search request is received from a client, the reference database for performance data which coincides with the information. Further, the user executes the programs to cause the communication interface 19 to function as search request receiving means for receiving an input of a search request and as search answer outputting means for transmitting a search answer to the client.

(4) Reference Database

The storage section 22 of the server S has stored therein a reference database wherein beverage information and performance data of fuel cells are associated with each other through ingredient data of the beverages. The reference database associates beverage information and performance data with each other based on the degree of substrate fitness and/or the degree of activity inhibition of ingredients contained in beverages with respect to enzymes fixed to an electrode of a fuel cell. A plurality of such reference databases are stored individually for a plurality of types of fuel cells.

Here, the beverage information includes the product name or the name of raw materials of the beverage or a code in which they are recorded. The raw material name includes the name of contained gradients listed on a raw material label on an outer face or the like of a container of the beverage or the name of contained gradients identified by ingredient analyses of the beverage though not listed on such a raw material label. As the raw material name, for example, saccharides such as high fructose corn syrup and sugar, acidulants, fragrances, lemon juice, caramel, coloring matters, sweeteners such as aspartame, L-phenylalanine compound, acesulfame potassium and xylitol, preservatives such as sodium benzoate and carrageenan, caffeine, vitamin C, table salt, tomato, apple, orange, grape, coffee, milk, malt, hop, rice, corn, starch, malted rice, brewed alcohol and the like. The code in which a product name and/or raw material names of a beverage are recorded includes an identifier such as, for example, a bar code which represents numerical values or characters depending upon the thickness of lines of stripe patterns or a two-dimensional code.

Where a beverage is used as fuel solution for a fuel cell, the performance of the fuel cell depends upon the substrate fitness degree, that is, whether an ingredient contained in the beverage can make a substrate of an enzyme fixed on an electrode of the fuel cell and/or upon whether an ingredient contained in the beverage inhibits the enzyme activity. In other words, the performance of a fuel cell depends upon the composition of a beverage used as fuel solution.

For example, a fuel cell in which a glucose decomposing enzyme is fixed on an electrode exhibits high output power and a long cell life if a beverage having a composition in which the concentration of a saccharide, particularly of sugar, is high is used as fuel solution. Also where Japanese sake or wine is used, output power of a certain level can be obtained because they contain sugar in the composition thereof. Meanwhile, from a beverage whose composition includes a sweetening other than sugar or includes only a saccharide other than glucose such as fructose, output power may not be obtained.

Meanwhile, in a fuel cell in which a fructose decomposing enzyme is fixed on an electrode, a fruit juice-based beverage having a composition in which the fructose concentration is high provides high output power and a long life. Since also wine contains fructose in the composition thereof, it can provide output power. On the other hand, an alcohol beverage produced from rice such as Japanese sake contains much sugar but contains a small amount of fructose, the cell performance is low.

The substrate fitness of an ingredient contained in a beverage can be so decided that, if the ingredient corresponds, for example, to any of the following substances although depending on the type of solid-phased enzyme, then the fitness is high. The substances include compounds such as saccharides, alcohols, aldehydes, fats, organic acids, proteins and amino acids and are enabled to serve as a substrate of an oxidoreductase. More particularly, the substances include saccharides such as glucose, fructose, sorbose and the like, alcohols such as methanol, ethanol, propanol, glycerine, polyvinyl alcohol and the like, aldehydes such as formaldehyde, acetaldehyde and the like, and organic acids such as acetic acid, formic acid, pyrubic acid and the like.

The oxidase fixed to the fuel electrode as an enzyme includes, for example, glucose dehydrogenase, gluconate 5-dehydrogenase, gluconate 2-dehydrogenase, alcohol dehydrogenase, aldehyde reductase, aldehyde dehydrogenase, lactate dehydrogenase, hydroxypyruvate reductase, glycerate dehydrogenase, formate dehydrogenase, fructose dehydrogenase, galactose dehydrogenase, malic acid dehydrogenase, glyceraldehydes 3-phosphate dehydrogenase, lactic acid dehydrogenase, sucrose dehydrogenase, fructose dehydrogenase, sorbose dehydrogenase, pyruvate dehydrogenase, isocirate dehydrogenase, 2-oxoglutarate dehydrogenase, succinate dehydrogenase, maleate dehydrogenase, acyl-CoA dehydrogenase, L-3-hydroxyacyl-CoA dehydrogenase, 3-hydroxypropionate dehydrogenase, 3-hydroxybutylate dehydrogenase and the like. As an oxidizable coenzyme, for example, nicotinamideadenine dinucleotide (herein after referred to as “NAD+”), flavin adenine dinucleotide (herein after referred to as “FAD+”), pyrrollo-quinolinequinone (herein after referred to as “PQQ2+”) and the like are available. For a coenzyme oxidase, for example, diaphorase and the like are available. The reductase fixed to the air electrode includes, for example, laccase, bilirubin oxidase, ascorbic acid oxidase, CueO, CotA and so forth.

As regards the degree of activity inhibition of an ingredient contained in a beverage, it can be decided that the activity inhibition of the ingredient is high where the ingredient corresponds, for example, to any of the following substances depending upon the type of solid-phased enzyme. The substances include iodoacetate, malonic acid, various types of surfactants, various types of oxidizing agents, heavy metals such as silver and mercury, parachloromercuribenzoate, mercury chloride, orthophenanthroline, and acetyl-CoA.

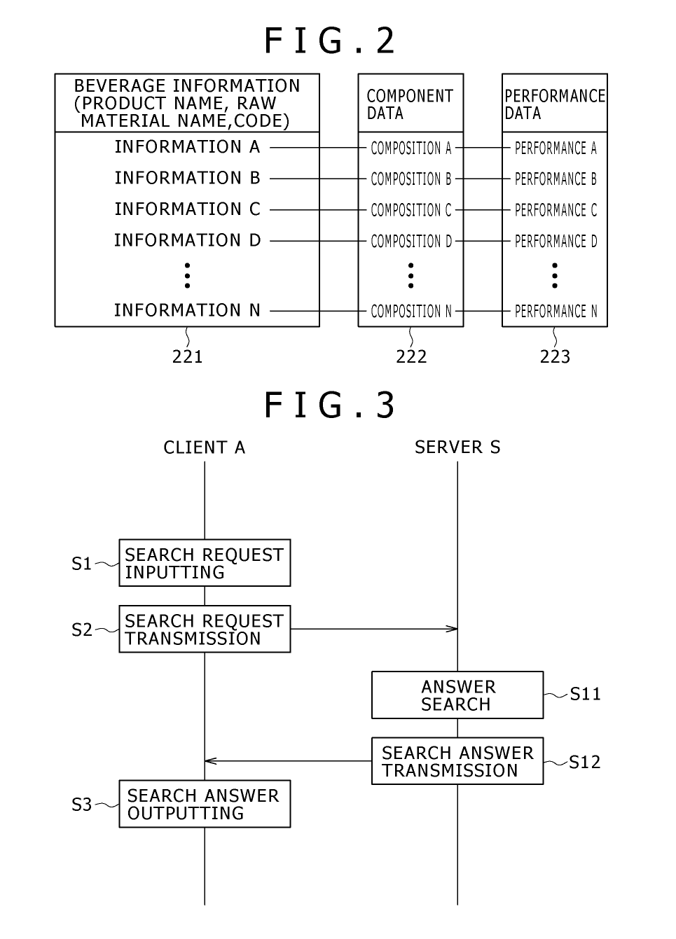

The reference data associate the drink information and the performance data through ingredient data of beverages based on a corresponding relationship between such ingredients of the beverages and the cell performances. FIG. 2 illustrates an example of a configuration of a reference database stored in the storage section 22.

Referring to FIG. 2, the reference database is configured from a beverage information table 221 in which product names or raw material names of drinks or codes are recorded, an ingredient data table 222 in which compositions of the drinks are recorded, and a performance data table 223 in which cell performances are recorded.

Information A in the beverage information table 221, for example, a product name A, is tied with a composition A of the beverage A in the ingredient data table 222, and further, the composition A of the beverage A in the ingredient data table 222 is tied with a performance A in the performance data table 223. Consequently, the beverage A is associated with the performance A where the beverage A is used as fuel solution.

2. System Operation

FIG. 3 illustrates an example of operation of the system.

For example, if a user of the client A wants to know fitness where a certain beverage is used as fuel solution of a certain fuel cell, it would use the inputting section 12 to input beverage information and fuel cell information as a search request at step S1.

Inputting of the search request can be carried out by text inputting, image inputting or sound inputting of the beverage information and/or the fuel cell information. Here, the fuel cell information includes the product name or the model number of the fuel cell or a code in which they are recorded.

In text inputting, the product name or raw material name of the beverage and the product name and the model number of the fuel cell are inputted from a keyboard. Meanwhile, in sound inputting, they are inputted from a microphone. In the image inputting, an image of the code in which they are recorded is picked up by a camera or the code is read by a reading apparatus such as a barcode reader to input the same. Inputting by an image may otherwise be carried out by picking up an image of the product name and the raw material name or the model number recorded on an outer face or the like of a beverage or a fuel cell directly by means of a camera and extracting the product name and the raw material name or the model number from the image using an image processing algorithm or a significance extraction algorithm.

The client A would transmit the inputted search request from the communication interface 11, which serves as an information transmission section, to the server S through the Internet. The search request transmitted to the server S is received by the communication interface 19 which functions as search request receiving means at step S2. As a result, the client A requests the server S for provision of performance data corresponding to the beverage information and the fuel cell information.

When the server S receives the search request from the client A, the search section 20 automatically searches the reference database stored in the storage section 22 for performance data corresponding to the received search request at step S11.

In particular, if the search request includes fuel cell information, then the search section 20 specifies that reference database which corresponds to the fuel cell information from among the plural reference databases stored for the different types of fuel cells.

Then, the search section 20 specifies information which coincides with the beverage information received as the search request from within the beverage information table 221 which configures the specified reference database as seen from FIG. 2. In other words, the search section 20 specifies information which corresponds to the product name or the raw material name of the beverage or the code in which they are recorded such as, for example, the “information A.”

The information A, for example, the product name A, in the beverage information table 221 is tied with the composition A of the beverage A in the ingredient data table 222, and the composition A of the beverage A in the ingredient data table 222 is tied with the performance A in the performance data table 223. The search section 20 thus specifies the performance A from the information A received as the search request through the composition A.

Then, if performance data corresponding to the beverage information and the fuel cell information inputted as the search request is found from within the reference database, then the search section 20 reads out the performance data as a search answer from the storage section 22. The search answer thus read out is provided from the communication interface 19, which functions as a search answer outputting section, to the client A through the Internet at step S12.

The client A receives the search answer from the communication interface 11, which functions as a search answer reception section, and presents the search answer through the presentation section 13 at step S3.

The presentation form of the search answer to the client A may be, for example, transmission of an electronic mail which describes the performance data or provision of the performance data and associated information on a homepage. Where the provision on a homepage is used, an electronic mail which describes a URL of the homepage or the like may be transmitted to the client A such that the user can access the homepage from the client A.

Meanwhile, the presentation of the search answer by the client A may be outputting of the performance data in the form of a text or sound or in the form of an image from which the user can grasp the performance through a visual sense.

With the system of the present application, where a user of a fuel cell intends to use a beverage on the market as fuel for the fuel cell, it can decide the fitness of the beverage as the fuel cell simply and conveniently. Although a fuel cell which uses an enzyme which decomposes saccharides such as glucose or alcohols such as ethanol is being turned into practical use at the present stage, also development of a fuel cell wherein beverage type oil such as, for example, olive oil is used as fuel using an enzyme for decomposing fat and a fuel cell wherein an amino acid beverage or a protein beverage is used as fuel using an amino acid decomposing enzyme or a proteolytic enzyme is being proceeded. In the present system, the fitness between such fuel cells and beverages as fuel solution is provided in a simple and convenient form to a user to allow the user to select a suitable beverage in accordance with each fuel cell and use the beverage as fuel solution. Consequently, a failure or an accident of a fuel cell caused by use of an unsuitable beverage can be prevented.

In summary, with the system of the present application, where a user of a fuel cell intends to use a beverage on the market as fuel for the fuel cell, the user can decide the fitness of the beverage with the fuel cell simply and conveniently.

It should be understood that various changes and modifications to the presently preferred embodiments described herein will be apparent to those skilled in the art. Such changes and modifications can be made without departing from the spirit and scope and without diminishing its intended advantages. It is therefore intended that such changes and modifications be covered by the appended claims.

The application is claimed as follows:

1. A system for inquiring about fitness of a beverage as battery fuel, comprising:
search request receiving means for receiving an input of beverage information regarding a beverage as a search request;
storage means having stored therein a reference database in which search requests and performance data of fuel cells are associated with each other;
search means for automatically searching the reference database for performance data which coincides with the search request; and
search answer outputting means for outputting a search answer.

2. The system according to claim 1, wherein the beverage information and the performance data in the reference database are associated with each other through ingredient data of beverages.

3. The system according to claim 2, wherein the reference database associates the beverage information and the performance data with each other based on a degree of substrate fitness and a degree of activity inhibition of ingredients included in the beverage with respect to an enzyme varied to a solid phase in an electrode of the fuel cell.

4. The system according to claim 3, wherein the ingredients include one or more elements selected from the group having sugars, alcohols, fats, organic acids and amino acids.

5. The system according to claim 4, wherein the beverage information is information regarding one or more pieces of information selected from a product name and a raw material name of the beverage and a code for recording the product name and raw material name.

6. The system according to claim 5, wherein the beverage information is image information obtained by picking up an image of the code.

7. The system according to claim 6, wherein said search request receiving means further receives fuel cell information regarding the fuel cell as the search request, and said storage means stores a plurality of reference databases for individual kinds of fuel cells.

8. The system according to claim 2, wherein the reference database associates the beverage information and the performance data with each other based on a degree of substrate fitness or a degree of activity inhibition of ingredients included in the beverage with respect to an enzyme varied to a solid phase in an electrode of the fuel cell.

9. The system according to claim 8, wherein the ingredients include one or more elements selected from the group having sugars, alcohols, fats, organic acids and amino acids.

10. The system according to claim 9, wherein the beverage information is information regarding one or more pieces of information selected from a product name and a raw material name of the beverage and a code for recording the product name and raw material name.

11. The system according to claim 10, wherein the beverage information is image information obtained by picking up an image of the code.

12. The system according to claim 11, wherein said search request receiving means further receives fuel cell information regarding the fuel cell as the search request, and said storage means stores a plurality of reference databases for individual kinds of fuel cells.

13. The system according to claim 1, wherein a server and a plurality of clients are connected to each other through a network, and
each of the clients including
inputting means for allowing a user to input beverage information regarding a beverage as a search request therethrough,
information transmission means for transmitting the inputted search request to the server,
search answer reception means for receiving, where the server stores performance data which coincides with the search request, the performance data as a search answer from the server, and
presentation means for presenting the received search answer to the user,
the server including
search request receiving means for receiving an input of beverage information as a search request,
storage means having stored therein a reference database in which search requests and performance data of fuel cells are associated with each other,
search means for automatically searching, where a search request is received from the client, the reference database for performance data which coincides with the search request, and
search answer outputting means for transmitting a search answer to the client.
